(19) United States
(12) Patent Application Publication
(10) Pub. No.: US 2025/0131472 A1
(43) Pub. Date: Apr. 24, 2025

(54) METHODS AND ELECTRONIC DEVICES FOR RE-ENGAGING USERS AND PROVIDING SUGGESTION INFORMATION

(71) Applicant: Hangzhou Alibaba International Internet Industry Co., Ltd., Hangzhou (CN)

(72) Inventors: Chao FEI, Hangzhou (CN); Zhengce Tao, Hangzhou (CN); Wei Li, Hangzhou (CN); Luying Zhang, Hangzhou (CN)

(21) Appl. No.: 18/924,738

(22) Filed: Oct. 23, 2024

(30) Foreign Application Priority Data
Oct. 24, 2023 (CN) 202311388262.5

(51) Int. Cl. G06Q 30/0251

(52) U.S. Cl. CPC G06Q 30/0253; G06Q 30/0255

(57) ABSTRACT

A method including acquiring user behavior data generated in a first service module of a commodity information service system, wherein the user behavior data includes behavior data generated in a process of a user interacting with the first service module by browsing commodity information published therein; determining, by analyzing the user behavior data, a target user having a commodity purchase intention and having difficulty in finding or deciding on commodities in the first service module; and after the target user is determined, re-engaging the target user with a second service module of the commodity information service system so that the target user may initiate a purchase form in the second service module and interact therewith. Through the embodiments of the present disclosure, the user re-engagement efficiency is improved, and resource waste is reduced.

### CROSS-REFERENCE TO RELATED APPLICATIONS

This application claims benefit of and priority to Chinese Patent Application No. 202311388262.5, filed on 24 Oct. 2023, all of which is hereby incorporated by reference in its entirety for all purposes as if fully set forth herein.

### TECHNICAL FIELD

The present disclosure relates to the technical field of information processing, and more particular, to a method and an electronic device for re-engaging users and providing suggestion information.

### BACKGROUND

For commodity information service systems/platforms, buyers are the primary customers thereof. At the same time, traffic is the lifeline of Internet products. Therefore, user growth becomes the long-term strategy of the platform. Common user growth strategies include those based on search engine optimization, brand/product power effects, user re-engagement, and other methods. Among these, user re-engagement usually refers to the process of bringing “dormant” customers back to the platform, “awakening” users by pushing marketing messages thereto, thus achieving user retention.

When it comes to user re-engagement, the core issues to be addressed are “who” (marketing audience), “what” (marketing content), “where” (marketing channels, including email/in-site message push, etc.), and “when” (marketing timing). The current mainstream marketing platforms, however, mainly focus on who, what, and where, i.e., marketing population, content, and channels. As for when, marketing timing, most application scenarios use the timed task re-engagement method. An example is to identify a population at a fixed time point, assemble marketing content, and then send/push the marketing content to the identified population.

However, this approach may lead to the marketing content being regarded as advertisements and ignored by users, making it difficult to truly play the role of re-engaging users, resulting in wasting relevant marketing resources. Therefore, how to improve the efficiency of user re-engagement and reduce resource waste has become a technical problem that needs to be addressed by those skilled in the art.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method and electronic device for user re-engagement and providing suggestion information, which can improve user re-engagement efficiency and reduce resource waste.

The present disclosure provides the following solutions.

A user re-engagement method, comprising:
acquiring user behavior data generated in a first service module of a commodity information service system, wherein the user behavior data comprises: behavior data generated in a process of a user interacting with the first service module by browsing commodity information published therein;
determining, by analyzing the user behavior data, a target user having a commodity purchase intention and having difficulty in finding or deciding on commodities in the first service module; and
after the target user is determined, re-engaging the target user with a second service module of the commodity information service system so that the target user may initiate a purchase form in the second service module and interact therewith.

Herein, the behavior data comprises behavior data generated by the user in a plurality of sub-service modules within the first service module;
the acquiring user behavior data stream generated in the first service module of the commodity information service system comprises:
acquiring, from a general user behavior data stream log, a user behavior data stream generated in the first service module so as to determine the target user by extracting and analyzing valid data therefrom, wherein the general user behavior data stream log is used to collect the user behavior data from the first service module and provide data services for downstream applications.

The method further comprises:
acquiring pre-configured re-engagement condition information, wherein the re-engagement condition information is generated by selecting from a plurality of data metrics and configuring thresholds, the selected data metrics and configured thresholds being determined based on user behaviors related to commodity purchase intentions and difficulty in finding or deciding on commodities in the first service module;
the determining, by analyzing the user behavior data, the target user having the commodity purchase intention and has difficulty in finding or deciding on commodities in the first service module comprises:
aggregating data values under various data metrics on a user-by-user basis by analyzing the user behavior data; and
determining the target user according to whether the data values under the plurality of data metrics match the re-engagement conditions.

Herein, the re-engagement condition information is adjustable, so that when a user re-engagement effect is not as expected, the re-engagement condition is adjusted by selecting other data metrics and/or configuring other thresholds.

The method further comprises:
performing flow control and/or user fatigue control in the process of re-engaging the target user with the second service module of the commodity information service system.

Herein, in the process of re-engaging the target user with the second service module of the commodity information service system, marketing content is assembled and sent to the target user through a target marketing channel, wherein the marketing content is related to the commodity information associated with the real-time behavior data.

The marketing content comprises a landing page corresponding to a marketing notification message, the landing page being generated through a visual construction system, and user behavior data is collected by adding anchors in the landing page, so as to track the user re-engagement effect.

A user re-engagement method, comprising:
providing, in response to a request to configure a user re-engagement condition, a plurality of alternative data metrics, the data metrics being related to behavior data generated in a process of a user interacting with a first service module of a commodity information service system by browsing commodity information published therein;
generating user re-engagement conditions according to at least one selected data metric and configured threshold information; and
configuring the generated user re-engagement conditions into a user re-engagement service, so that the user re-engagement service determines, after acquiring user behavior data generated in a first service module and aggregating it into data values under the data metrics, a target user having commodity purchase intention and has difficulty in finding or deciding on commodities in the first service module according to matches of the user re-engagement conditions, and re-engages the target user with a second service module of the commodity information service system, so as to enable the target user to initiate a purchase form in the second service module and interact therewith.

Herein, the re-engagement condition information is adjustable, so that when a user re-engagement effect is not as expected, the re-engagement condition is adjusted by selecting other data metrics and/or configuring other thresholds.

A method for providing suggestion information, comprising:
acquiring user behavior data generated in a first service module of a commodity information service system, wherein the user behavior data comprises: behavior data generated in a process of a user interacting with the first service module by browsing commodity information published therein;
determining, by analyzing the user behavior data, a target user having a commodity purchase intention and having difficulty in finding or deciding on commodities in the first service module; and
providing, after the target user is determined, suggestion information thereto, so that the target user may interact by initiating a purchase form in a second service module of the commodity information service system.

A user re-engagement apparatus, comprising:
a data acquisition unit, configured for acquiring user behavior data generated in a first service module of a commodity information service system, wherein the user behavior data comprises: behavior data generated in a process of a user interacting with the first service module by browsing commodity information published therein;
a data analysis unit, configured for determining, by analyzing the user behavior data, a target user having a commodity purchase intention and having difficulty in finding or deciding on commodities in the first service module; and
a user re-engagement unit, configured for: after the target user is determined, re-engaging the target user with a second service module of the commodity information service system so that the target user may initiate a purchase form in the second service module and interact therewith.

A user re-engagement apparatus, comprising:
a data metric providing unit, configured for providing, in response to a request to configure a user re-engagement condition, a plurality of alternative data metrics, the data metrics being related to behavior data generated in a process of a user interacting with a first service module of a commodity information service system by browsing commodity information published therein;
a re-engagement condition generating unit, configured for generating user re-engagement conditions according to at least one selected data metric and configured threshold information; and
a re-engagement condition configuration unit, configured for configuring the generated user re-engagement conditions into a user re-engagement service, so that the user re-engagement service determines, after acquiring user behavior data generated in a first service module and aggregating it into data values under the data metrics, a target user having commodity purchase intention and has difficulty in finding or deciding on commodities in the first service module according to matches of the user re-engagement conditions, and re-engages the target user with a second service module of the commodity information service system, so as to enable the target user to initiate a purchase form in the second service module and interact therewith.

An apparatus for providing suggestion information, comprising:
a data acquisition unit, configured for acquiring user behavior data generated in a first service module of a commodity information service system, wherein the user behavior data comprises: behavior data generated in a process of a user interacting with the first service module by browsing commodity information published therein;
a data analysis unit, configured for determining, by analyzing the user behavior data, a target user having a commodity purchase intention and having difficulty in finding or deciding on commodities in the first service module; and
a suggestion information providing unit, configured for providing, after the target user is determined, suggestion information thereto so that the target user may interact by initiating a purchase form in a second service module of the commodity information service system.

A computer-readable storage medium having stored thereon a computer program which, when executed by a processor, implements the steps described in any of the above-described methods.

An electronic device, comprising:
one or more processors; and
a memory associated with the one or more processors, the memory being configured to store computer-readable instructions which, when read and executed by the one or more processors, cause the one or more processors to execute the steps described in any of the above-described methods.

According to example embodiments provided by the present disclosure, the present disclosure discloses the following technical effects:

Through the embodiments of the present disclosure, user behavior data generated in the first service module of the commodity information service system can be acquired, which is the behavior data generated in the process of a user interacting with the first service module by browsing commodity information published therein. By analyzing the user behavior data, a target user having a commodity purchase intention and having difficulty in finding or deciding on commodities in the first service module can be determined. Afterwards, the target user may be re-engaged by being brought to the second service module of the commodity information service system, so that the user may initiate a purchase form in the second service module and interact therewith. In this way, users can be re-engaged based on their behavior data. For example, when it is determined that a user has a shopping intention based on the user's behavior data in the first service module but encounters some difficulties in the first service module, the user will be re-engaged and brought to the second service module. In this way, for the user, the received re-engagement information may be exactly what he needs without realizing it at the time. Therefore, the specific re-engagement will be more easily accepted by the user, thereby improving the success rate of user re-engagement, reducing resource waste, and further helping user retention or user growth in the second service module.

In an example implementation, the embodiment of the present disclosure may further provide a re-engagement condition configuration system, in which a variety of alternative data metrics may be provided, and through which a more complete and comprehensive user profile may be achieved. Specific operation personnel may complete the setting of re-engagement conditions by selecting data metrics therefrom and configuring thresholds. Afterwards, the re-engagement effect can be determined. If it is not as expected, the data metrics may then be changed, or the thresholds may then be modified, etc., thus making the entire solution easy to expand and highly configurable with an easily maintainable system.

In addition, when user behavior data is to be acquired, since the specific behavior data may be dispersed in a plurality of different sub-modules, at this time, it is possible to acquire the user behavior data stream from the general log system, filter out invalid data, and aggregate per data metrics, etc., to acquire the user-specific data values under multiple data metrics, so as to reduce the technical modification cost or communication cost of each sub-module.

Implementation of any solutions of the present disclosure does not necessarily need to achieve all of the advantages described above.

### BRIEF DESCRIPTION OF DRAWINGS

To describe the technical solutions in the embodiments of the present disclosure or in the conventional techniques more clearly, the following briefly describes the accompanying drawings required for describing the embodiments. Apparently, the accompanying drawings in the following description are merely some embodiments of the present disclosure, and those of ordinary skill in the art may further derive other accompanying drawings from these accompanying drawings without inventive efforts.

FIG. 1 is a schematic diagram of a system architecture provided by an embodiment of the present disclosure;

FIG. 2 is a flowchart of a first method provided by an embodiment of the present disclosure;

FIG. 3 is a schematic diagram of marketing content provided by an embodiment of the present disclosure;

FIG. 4 is a flowchart of a second method provided by an embodiment of the present disclosure;

FIG. 5 is a flowchart of a third method provided by an embodiment of the present disclosure; and

FIG. 6 is a schematic diagram of an electronic device provided by an embodiment of the present disclosure.

### DESCRIPTION OF EMBODIMENTS

The technical solutions in the embodiments of the present disclosure will be clearly and completely described below with reference to the accompanying drawings in the embodiments of the present disclosure. Apparently, the described embodiments are merely some, but not all, of the embodiments of the present disclosure. Based on the embodiments in the present disclosure, all other embodiments obtained by a person of ordinary skill in the art shall fall within the protection scope of the present disclosure.

In the embodiment of the present disclosure, in order to improve the efficiency of user re-engagement and reduce resource waste, the triggering timing of user re-engagement (“when”—marketing timing) is improved. Instead of a timed re-engagement method, a user re-engagement solution based on real-time user behavior data is adopted. That is, based on the real-time behavior data generated by the user in the system, whether marketing content should be pushed to the user is determined.

It should be noted herein that user re-engagement solutions based on their real-time behavior are seen in some existing commodity information service systems. However, the logic of the re-engagement is mainly to guide users to browse more commodity information. For example, if it is found that a user has browsed five commodities in the last ten minutes but has not taken any further action, marketing content may then be pushed to the user. The marketing content would usually still contain commodity information, such as another set of commodities recommended based on the above five commodities, and so on.

The following characteristics, however, can be seen in the commodity information service system described in the embodiments of the present disclosure: the system may provide users with two main interaction methods. One method is that the user starts by browsing commodity information, including searching commodities, browsing by categories, searching by stores, and browsing the recommended commodity information flow of the page, and then browsing the commodity details page, initiating an inquiry to the merchants corresponding to the specific commodities, and the like. The other method is to start with a consumer user submitting a purchase form. For example, when the consumer user has a purchase intention, he can fill out a purchase order in the system and provide a description for the desired commodity. After that, multiple merchants on the site can search or be recommended for this “business opportunity” within the “market” page. If a merchant is able to undertake the request, this merchant can provide an offer and provide a description of the commodities it is able to offer, and so on. Afterwards, the consumer user may collect the offer information of multiple merchants, and may also compare the commodity parameters, prices, etc. of all merchants, so as to determine which commodity meeting the needs and the cost. If a suitable merchant can be determined, communication and ordering may be carried out on the site.

The above two interaction methods usually correspond to two different service modules provided by the commodity information service system (for the sake of distinction, the service module corresponding to the above-mentioned first interaction method is referred to as the “first service module” in the embodiment of the present disclosure; accordingly, the service module corresponding to the second interaction method is referred to as the “second service module”). Users can choose which service module to use for interaction according to their needs, and they may certainly switch therebetween so that the two service modes of the two service modules may complement each other, helping users to reach a deal.

However, in actual applications, some users may be accustomed to using the above-mentioned first service module in that they mainly start from browsing the commodity information published in the system to find commodities that meet their needs, and the second service module is ignored. Alternatively, when users spend time but are unable to find suitable commodities or find it difficult to decide on commodities in the first service module, the existence of the second service module is not thought of in time, and so on.

Therefore, in the embodiment of the present disclosure, for example, when a user is re-engaged based on real-time user behavior data, whether the user has the intention to purchase the commodity may be determined based on the real-time behavior data generated by the user when using the first service module. If so, but no specific operations such as placing an order are performed in the first service module, it can be inferred that the user may have some difficulties in the first service module. For example, the user may not be able to find the desired commodity, or cannot make a shopping decision due to factors such as commodity parameters and prices, etc. At this time, the user can be re-engaged and brought to the second service module so that the user may interact therewith by actively initiating a purchase form. This method helps users to find commodities that meet their needs or make decisions in more ways. At the same time, it may also bring more user traffic or achieve user growth for the above-mentioned second service module of the system.

In addition, in an embodiment of the present disclosure, in order to more accurately discover the user's commodity purchase intention through the user's real-time behavior data in the first service module, and determine whether the user has difficulty in finding or deciding on commodities in the first service module, a variety of alternative data metrics may be provided, such as the number of viewed commodities within a certain period of time, the number of commodities that have been shown to a certain user within a certain period of time, time when the user logs in, commodities with inquiries sent, whether a visit to a specific page exists, etc. These data metrics can enrich the user profile. In addition, one or some data metrics may be selected therefrom, and specific thresholds may be configured to complete the configuration of the re-engagement conditions. Selecting metrics and configuring thresholds may certainly be done based on observations of user behavior. After specific re-engagement conditions are configured, these can be configured to the specific user re-engagement services, so that user behavior matching may be determined and user re-engagement may be performed based on the conditions. After running for a period of time, whether the specific re-engagement effect meets expectations may be determined. If it does not, the re-engagement conditions can be adjusted by, for example, selecting other data metrics, or modifying thresholds, etc., so as to achieve a more flexible user re-engagement strategy.

Herein, the first service module may be subdivided into a plurality of different sub-modules. For example, the one related to commodity browsing is a “commodity” sub-module, and there may also be a sub-module related to “inquiry”, a sub-module related to “order”, and so on, which may correspond to different development teams. At this time, in the case where multiple alternative data metrics are provided as mentioned above, the behavior of the user generated in the first service module may be scattered in the plurality of different sub-modules, which means that it may be necessary to respectively acquire user behavior data from the plurality of different sub-modules. If a conventional solution is used, then it may involve technical modifications made to the plurality of different sub-modules so that the user re-engagement service may access specific sub-modules to acquire user behavior data; or, it may involve allowing the plurality of different sub-modules to add anchors to their related front-end pages, so that when behavior of the user related to a specific sub-module is generated, the specific sub-module may notify the user re-engagement service, and so on. However, whether it is directly adapting the code of specific sub-modules or requiring sub-modules to provide notifications, there will be high technical or communication costs.

In view of this situation, in an example embodiment of the present disclosure, it is also possible to acquire the user behavior data stream generated in the first service module from a general user real-time behavior data stream log, and then extract and analyze valid data therefrom, then processing such as aggregation of the data metrics and matching judgment with the re-engagement conditions may be performed. The above-mentioned user real-time behavior data stream log may, for example, be a universal log system established in the commodity information service system, which can record the user behavior data generated in the plurality of different sub-modules of the first service module. This data can be used as an asset and provided to a variety of different downstream applications for use. Herein, different downstream applications have different ways of using this data asset. Accordingly, the data in this data asset will also be relatively complicated. Therefore, in the embodiment of the present disclosure, after pulling the user's real-time behavior data stream from the log system, filtering analysis may be performed to filter out invalid parts and retain the valid parts. Then, aggregation may be performed on a user-by-user basis to obtain the data value of the same user under specific data metrics, which is then compared with the set threshold in the re-engagement conditions, so as to determine whether the user is the target user that needs to be re-engaged according to the embodiment of the present disclosure.

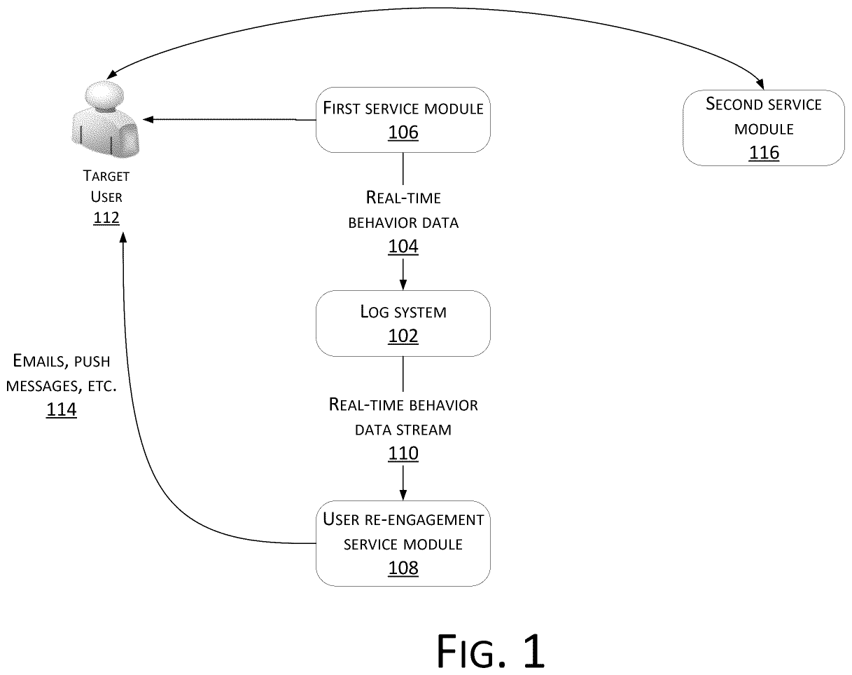

From the perspective of the system architecture, referring to FIG. 1, the embodiment of the present disclosure may provide a user re-engagement service for a commodity information service system, and the service may be run in an environment such as a backend server of the commodity information service system. In an example implementation, the service may acquire, from a log system 102 such as general user behavior log system, the real-time user behavior data 104 generated in the first service module 106 of the commodity information service system, and then the user re-engagement service module 108 analyzes the real-time behavior data stream 110 from the log system 102 to determine the target user 112 who has the intention to purchase the commodities and has difficulty in finding or deciding on commodities in the first service module 106. After that, re-engagement methods like sending emails or pushing notification messages, etc. 114 to the target user 112 may be used to re-engage the target user 112 with the second service module 116.

The example implementation solutions provided by the embodiments of the present disclosure are described in detail below.

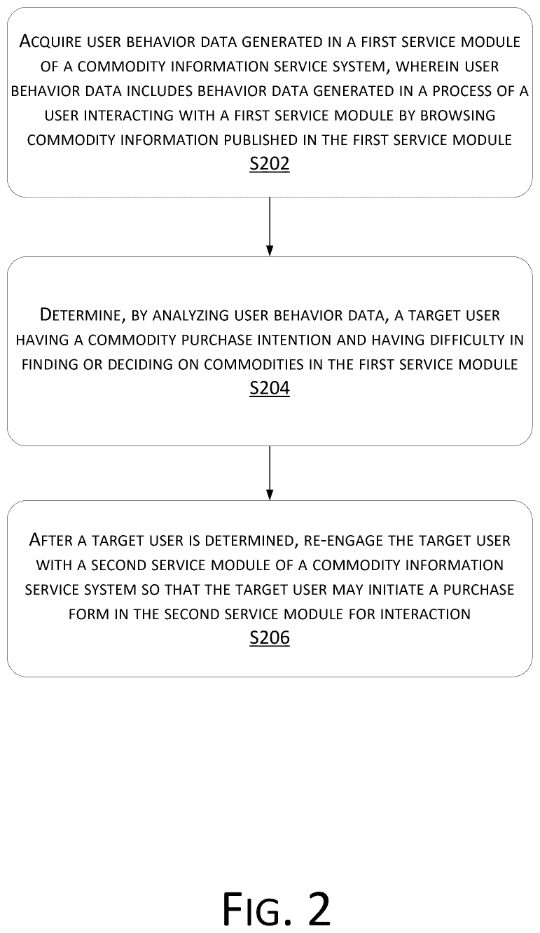

First, from the perspective of the aforementioned user re-engagement service, an example embodiment provides a user re-engagement method. Referring to FIG. 2, the method may include:

S202: acquiring user behavior data generated in a first service module of a commodity information service system, wherein the user behavior data includes behavior data generated in a process of a user interacting with the first service module by browsing commodity information published in the first service module.

The user behavior data generated in the first service module is the behavior data generated in the process of users interacting therewith by browsing the commodity information published therein, which may be, for example, real-time behavior data. In the example implementation, some data metrics may certainly be pre-defined. According to the definitions of the data metrics, example real-time behavior data can be acquired for each user. For example, the data metrics may include: how many commodities a specific user has browsed within a certain period of time; how many commodities are shown to a certain user within a certain period of time, and so on. The reason for acquiring data on these data metrics is that, through preliminary analysis, it is found that the user behavior data on these data metrics can reflect whether the user has the intention to purchase the commodity and whether the user encounters some difficulties during the interaction with the first service module.

In the example implementation, as described above, in an example implementation method, a variety of alternative data metrics may be provided for configuring the re-engagement conditions, and then the user's real-time behavior data can be acquired based on the data metrics used in the re-engagement conditions. In other words, only the behavior data related to these data metrics needs to be acquired. For example, the metrics used in the re-engagement conditions and the thresholds of the specific metrics may be configured according to specific operation strategies, etc., and may also be adjusted after the re-engagement conditions are configured, including replacing some data metrics, or modifying specific thresholds, etc.

In an example implementation, the specific user behavior data may include behavior data generated by the user in a plurality of sub-service modules in the first service module. At this time, in an example implementation, the specific acquisition of the user behavior data generated in the first service module of the commodity information service system may be acquiring, from a general user behavior data stream log, a user behavior data stream generated in the first service module so as to determine the target user by extracting and analyzing valid data therefrom, wherein the general user behavior data stream log is used to collect the user behavior data from the first service module and provide data services for downstream applications.

Since the data recorded in the above-mentioned general log system may be relatively complicated and may contain content irrelevant to the data required in the embodiment of the present disclosure, filtering analysis may further be performed to filter out the invalid parts and retain the valid parts after the user's real-time behavior data stream is pulled from the log system. Then, aggregation may be performed on a user-by-user basis to obtain the data values of the same user under specific data metrics.

In a scenario where the technical cost or communication cost is not a concern, the specific real-time behavior data may certainly be directly acquired from the plurality of sub-modules of the first service module without the help of a general log system, which is not limited herein.

S204: determining, by analyzing the user behavior data, a target user having a commodity purchase intention and having difficulty in finding or deciding on commodities in the first service module.

After the specific user behavior data is acquired, a target user having a commodity purchase intention and having difficulty in finding or deciding on commodities in the first service module may be determined based on the data. For example, if the re-engagement conditions are pre-configured, including specific data metrics and thresholds, the user behavior data may then be analyzed and aggregated into data values under a plurality of data metrics on a user-by-user basis, and then the target user may be determined according to whether the data values under the plurality of data metrics match the re-engagement conditions.

S206: after the target user is determined, re-engaging the target user by bringing the same to a second service module of the commodity information service system so that the target user may initiate a purchase form in the second service module for interaction.

After the target user matching the re-engagement condition is determined, the target user may be re-engaged and brought to the second service module of the commodity information service system so that the target user may start interacting with the second service module by initiating a purchase form. That is to say, in the embodiment of the present disclosure, it is based on the behavior data generated by the user in the first service module that determines which target user to re-engage and when to do so. For example, instead of continuing to re-engage user by recommending a different set of commodities, the target user will be re-engaged by being brought to the second service module so that the user may change the interaction method, thus enabling the user to find the desired commodities or make decisions. In other words, in the embodiment of the present disclosure, after the behavior data generated by the user in the first service module is analyzed, if it is found that the user indeed has the intention to purchase, but has carried out a large number of browsing, comparison, and other operations without proceeding to the ordering step, at this point, if only changing the set of commodities for recommendation is offered and the user is let to remain in the first service module, then the user is not really assisted. Therefore, in the embodiment of the present disclosure, the re-engagement logic is modified. Since the user has performed many operations in the first service module, it is evident that the interaction method provided by the first service module may not be suitable for the current user. As such, the user may be re-engaged and brought to the second service module, and the interaction is carried out by the user first initiating a purchase form. In this way, instead of searching from a large amount of commodity information published by the system the user is in, it is possible to change to that the user publishes his own purchasing needs, including the desired commodity categories, needs in commodity parameters, prices, etc., and then merchants may determine whether their commodities match the user's purchasing needs. If so, a response may be made, and the like. Through this method, users are assisted in finding the commodities they need or in making decisions, thereby increasing the probability of entering the ordering step.

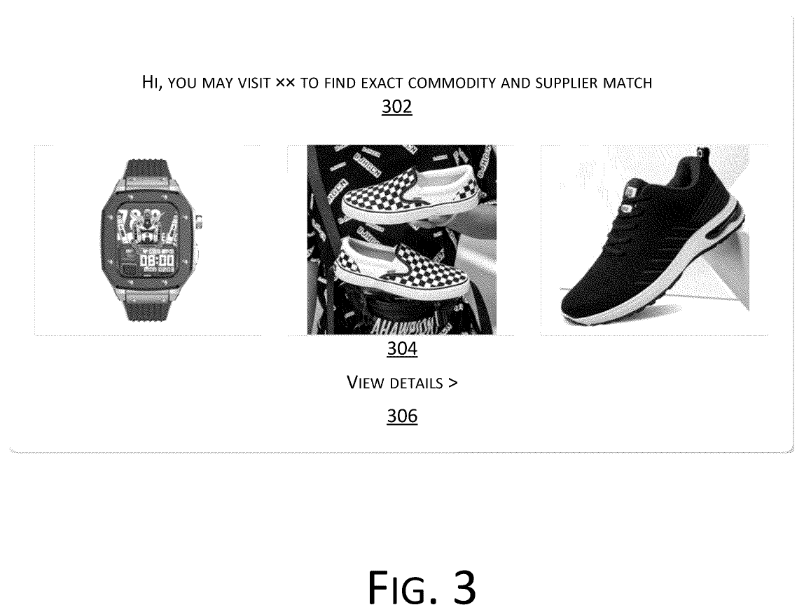

For example, after the target users who need to be re-engaged are determined, marketing content can be assembled and sent to the target users through target marketing channels. For example, outreach can be performed through channels such as email or site messages push. The specific marketing content may be related to the commodity information associated with the specific real-time behavior data. For example, assuming that it is found that the user has recently browsed and compared certain commodities repeatedly in the first service module but has not placed an order, the user may be re-engaged and brought to the second service module, and the information related to the browsed commodities can be reflected in the marketing content pushed to the user, and the specific marketing text can be processed so that the user is aware of the specific role the sent email or push message plays. For example, referring to FIG. 3, the specific marketing text 302 may be “Hi, you may visit xx to find the exact commodity and supplier match,” where “xx” may refer to the name of the aforementioned second service module, etc., and then commodity images 304 of representative commodities related to the specific behavior data in the aforementioned first service module and the like may be displayed below the text to enhance the user's perception of the specific marketing content. The target user may click a button such as view details button 306 to view details of the representative commodities.

In addition, a landing page corresponding to the specific marketing notification message may further be configured in the marketing content. The landing page may be generated through a visualization builder, including what sections, layers, banner images, etc. are to be included. Furthermore, user behavior data may further be collected by adding anchors in the landing page and the like to track the user re-engagement effect. As such, when the user re-engagement effect is not as expected, the re-engagement condition may be adjusted by selecting other data metrics and/or configuring other thresholds.

It should be noted that, for example, in the process of re-engaging the target user by bringing the same to the second service module of the commodity information service system, flow control and/or user fatigue control may further be performed. For example, if a re-engagement message has been sent to a user several times within a short period of time, even if the user's behavior data matches the recall condition again, the re-engagement action may be suspended temporarily so as not to antagonize the user.

In summary, through the embodiments of the present disclosure, user behavior data generated in the first service module of the commodity information service system can be acquired, which is the behavior data generated in the process of a user interacting with the first service module by browsing commodity information published therein. By analyzing the user behavior data, a target user having a commodity purchase intention and having difficulty in finding or deciding on commodities in the first service module can be determined. Afterwards, the target user may be re-engaged by being brought to the second service module of the commodity information service system, so that the user may initiate a purchase form in the second service module and interact therewith. In this way, users can be re-engaged based on their behavior data. For example, when it is determined that a user has a shopping intention based on the user's behavior data in the first service module but encounters some difficulties in the first service module, the user will be re-engaged and brought to the second service module. In this way, for the user, the received re-engagement information may be exactly what he needs without realizing it in time. Therefore, the specific re-engagement will be more easily accepted by the user, thereby improving the success rate of user re-engagement, reducing resource waste, and further helping user retention or user growth in the second service module.

In an example implementation, the embodiment of the present disclosure may further provide a re-engagement condition configuration system, in which a variety of alternative data metrics may be provided, and through which a more complete and comprehensive user profile may be achieved. Specific operation personnel may complete the setting of re-engagement conditions by selecting data metrics therefrom and configuring thresholds. Afterwards, the re-engagement effect can be determined. If it is not as expected, the data metrics may then be changed, or the thresholds may then be modified, etc., thus making the entire solution easy to expand and highly configurable with an easily maintainable system.

In addition, when user behavior data is to be acquired, since the specific behavior data may be dispersed in the plurality of different sub-modules, at this time, it is possible to acquire the user behavior data stream from the general log system, filter out invalid data, and aggregate per data metrics, etc., to acquire the user-specific data values under multiple data metrics, so as to reduce the technical modification cost or communication cost of each sub-module.

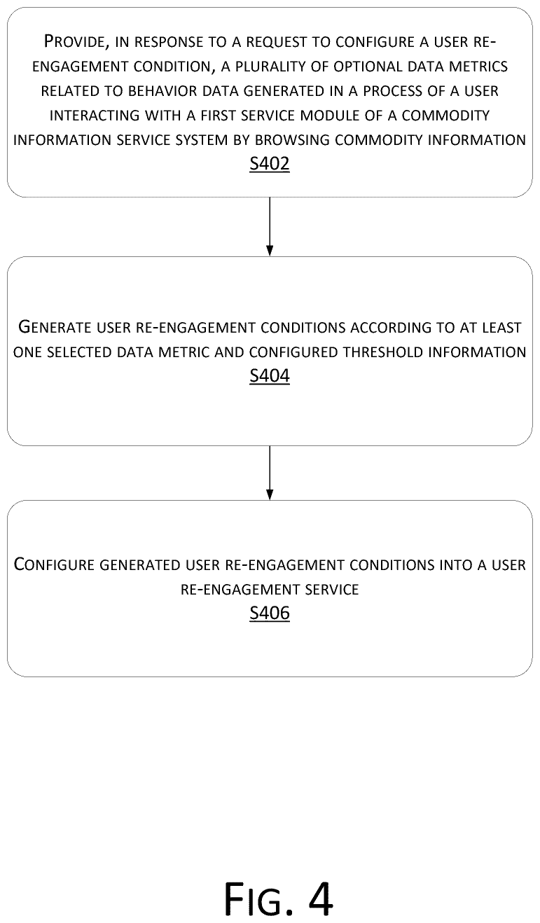

Another example embodiment provides a user re-engagement method from the perspective of the re-engagement condition configuration system. Referring to FIG. 4, the method may include:

S402: providing, in response to a request to configure a user re-engagement condition, a plurality of alternative data metrics related to behavior data generated in a process of a user interacting with a first service module of a commodity information service system by browsing commodity information published in the first service module;

S404: generating user re-engagement conditions according to at least one selected data metric and configured threshold information; and

S406: configuring the generated user re-engagement conditions into a user re-engagement service, so that the user re-engagement service determines, after acquiring user behavior data generated in a first service module and aggregating it into data values under the data metrics, a target user having commodity purchase intention and has difficulty in finding or deciding on commodities in the first service module according to matches of the user re-engagement conditions, and re-engages the target user with a second service module of the commodity information service system, so as to enable the target user to initiate a purchase form in the second service module and interact therewith.

Herein, the re-engagement condition information is adjustable, so that when a user re-engagement effect is not as expected, the re-engagement condition is adjusted by selecting other data metrics and/or configuring other thresholds.

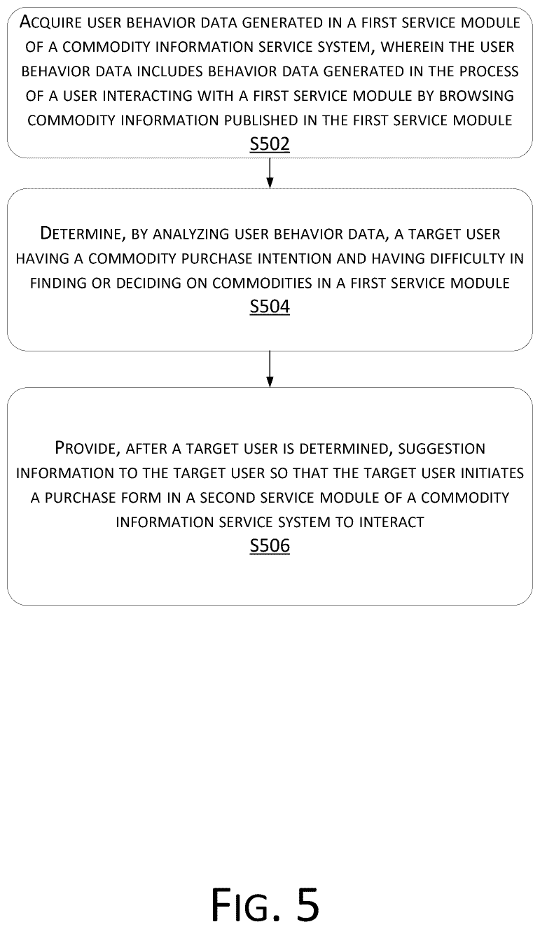

In the aforementioned example embodiments, after it is determined, based on the user's behavior data in the first service module, that the user has a commodity purchase intention, but has difficulty in finding or deciding on commodities therein, the user is re-engaged and directly brought to the second service module. In this example embodiment, however, instead of directly re-engaging the user and assembling re-engagement materials, suggestion information for using the second service module may be provided to the user, and the suggestion information may be sent to the user using a pop-up prompt in the page of the first service module. For example, this example embodiment provides a method for providing suggestion information. Referring to FIG. 5, the method may include:
S502: acquiring user behavior data generated in a first service module of a commodity information service system, wherein the user behavior data comprises: behavior data generated in a process of a user interacting with the first service module by browsing commodity information published in the first service module;
S504: determining, by analyzing the user behavior data, a target user having a commodity purchase intention and having difficulty in finding or deciding on commodities in the first service module; and
S506: providing, after the target user is determined, suggestion information to the target user so that the target user may initiate a purchase form in a second service module of the commodity information service system to interact.

For the parts not described in detail in some embodiments, reference may be made to the other embodiments and the other parts of this specification, which will not be described herein again.

It should be noted that the embodiments of the present disclosure may involve the use of user data. In practical applications, user-specific personal data may be used in the solutions described herein to the extent permitted by applicable laws and regulations (e.g., explicit consent from the users, effective notification to the users, etc.) in compliance with applicable laws and regulations of the country where the solutions are implemented.

Corresponding to an example method embodiment, the embodiment of the present disclosure further provides a user re-engagement apparatus, which may include:
a data acquisition unit, configured for acquiring user behavior data generated in a first service module of a commodity information service system, wherein the user behavior data comprises: behavior data generated in a process of a user interacting with the first service module by browsing commodity information published therein;
a data analysis unit, configured for determining, by analyzing the user behavior data, a target user having a commodity purchase intention and having difficulty in finding or deciding on commodities in the first service module; and
a user re-engagement unit, configured for: after the target user is determined, re-engaging the target user with a second service module of the commodity information service system so that the target user may initiate a purchase form in the second service module and interact therewith.

Herein, the behavior data comprises behavior data generated by the user in a plurality of sub-service modules within the first service module;
at this time, the data acquisition unit may, for example, be used for:
acquiring, from a general user behavior data stream log, a user behavior data stream generated in the first service module so as to determine the target user by extracting and analyzing valid data therefrom, wherein the general user behavior data stream log is used to collect the user behavior data from the first service module and provide data services for downstream applications.

In an example implementation, the apparatus may further include:
a re-engagement condition information acquisition unit, configured for acquiring pre-configured re-engagement condition information, wherein the re-engagement condition information is generated by selecting from a plurality of data metrics and configuring thresholds, the selected data metrics and configured thresholds being determined based on user behaviors related to commodity purchase intentions and difficulty in finding or deciding on commodities in the first service module;
at this time, the data analysis unit may be, for example, used for:
aggregating data values under various data metrics on a user-by-user basis by analyzing the user behavior data; and
determining the target user according to whether the data values under the plurality of data metrics match the re-engagement conditions.

Herein, the re-engagement condition information is adjustable, so that when a user re-engagement effect is not as expected, the re-engagement condition is adjusted by selecting other data metrics and/or configuring other thresholds.

In addition, the apparatus may further comprise:
a control unit, configured for performing flow control and/or user fatigue control in the process of re-engaging the target user with the second service module of the commodity information service system.

Furthermore, the device may further comprise:
a marketing content assembly unit, configured for: in the process of re-engaging the target user with the second service module of the commodity information service system, assembling and sending marketing content to the target user through a target marketing channel, wherein the marketing content is related to the commodity information associated with the real-time behavior data.

The marketing content comprises a landing page corresponding to a marketing notification message, the landing page being generated through a visual construction system, and user behavior data is collected by adding anchors in the landing page, so as to track the user re-engagement effect.

Corresponding to another example method embodiment, the embodiment of the present disclosure further provides a user re-engagement apparatus, which may comprise:
a data metric providing unit, configured for providing, in response to a request to configure a user re-engagement condition, a plurality of alternative data metrics, the data metrics being related to behavior data generated in a process of a user interacting with a first service module of a commodity information service system by browsing commodity information published therein;
a re-engagement condition generating unit, configured for generating user re-engagement conditions according to at least one selected data metric and configured threshold information; and
a re-engagement condition configuration unit, configured for configuring the generated user re-engagement conditions into a user re-engagement service, so that the user re-engagement service determines, after acquiring user behavior data generated in a first service module and aggregating it into data values under the data metrics, a target user having commodity purchase intention and has difficulty in finding or deciding on commodities in the first service module according to matches of the user re-engagement conditions, and re-engages the target user with a second service module of the commodity information service system, so as to enable the target user to initiate a purchase form in the second service module and interact therewith.

Herein, the re-engagement condition information is adjustable, so that when a user re-engagement effect is not as expected, the re-engagement condition is adjusted by selecting other data metrics and/or configuring other thresholds.

Corresponding to another example embodiment, the embodiment of the present disclosure further provides an apparatus for providing suggestion information, the apparatus may comprise:
a data acquisition unit, configured for acquiring user behavior data generated in a first service module of a commodity information service system, wherein the user behavior data comprises: behavior data generated in a process of a user interacting with the first service module by browsing commodity information published therein;
a data analysis unit, configured for determining, by analyzing the user behavior data, a target user having a commodity purchase intention and having difficulty in finding or deciding on commodities in the first service module; and
a suggestion information providing unit, configured for providing, after the target user is determined, suggestion information thereto so that the target user may initiate a purchase form in a second service module of the commodity information service system and interact therewith.

In addition, the embodiment of the present disclosure further provides a computer-readable storage medium having a computer program stored thereon which, when executed by a processor, implements the steps of the methods described in any of the above-described method embodiments.

Also provided is an electronic device, comprising:
one or more processors; and
a memory associated with the one or more processors, the memory being configured to store computer-readable instructions which, when read and executed by the one or more processors, cause the one or more processors to execute the steps of the methods described in any of the above-described method embodiments.

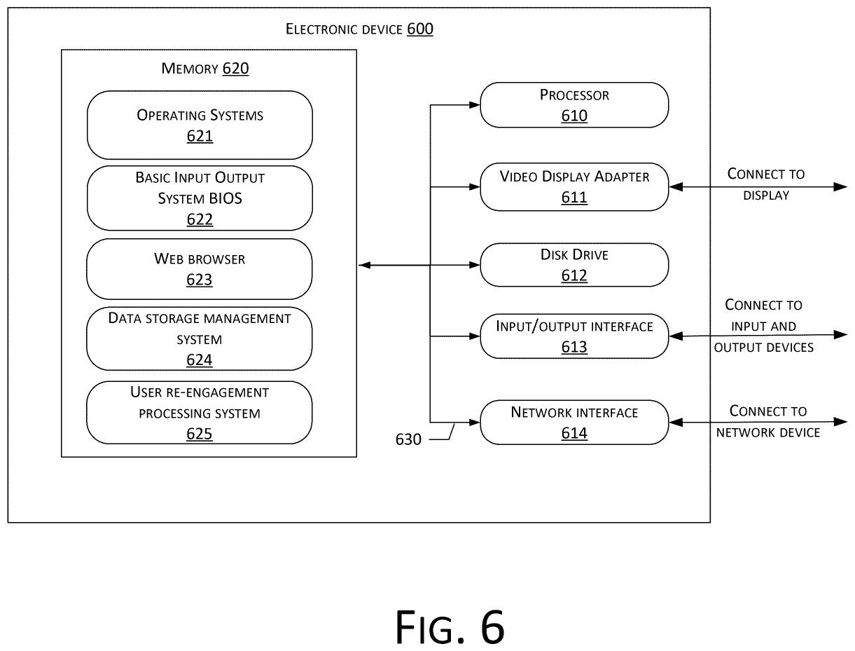

FIG. 6 exemplarily shows the architecture of the electronic device, which may, for example, include a processor 610, a video display adapter 611, a disk drive 612, an input/output interface 613, a network interface 614, and a memory 620. The processor 610, the video display adapter 611, the disk drive 612, the input/output interface 613, and the network interface 614 may be communicatively connected with the memory 620 via a bus 630 such as a communication bus.

Herein, the processor 610 may be implemented using a general-purpose CPU (Central Processing Unit) processor, a microprocessor, an application specific integrated circuit (Application Specific Integrated Circuit, ASIC), or one or more integrated circuits, configured for executing relevant programs to implement the technical solutions provided in the present disclosure.

The memory 620 may be implemented in the form of a ROM (Read Only Memory), a RAM (Random Access Memory), a static storage device, a dynamic storage device, etc. The memory 620 may store an operating system 621 for controlling the operation of the electronic device 600 and a basic input output system (BIOS) for controlling low-level operations of the electronic device 600. In addition, a web browser 623, a data storage management system 624, a user re-engagement processing system 625, and the like may also be stored therein. The user re-engagement processing system 625 may be an application program for implementing the operations of the aforementioned steps in the embodiments of the present disclosure. In summary, when the technical solutions provided in the present disclosure are implemented by software or firmware, the relevant program code is stored in the memory 620 and is called and executed by the processor 610.

The memory 620 may include a volatile memory on a computer-readable medium, a random-access memory (RAM) and/or a non-volatile memory, and the like, such as a read-only memory (ROM) or a flash random access memory (flash RAM). The memory 620 is an example of the computer-readable media.

Computer-readable media further include nonvolatile and volatile, removable and non-removable media employing any method or technique to achieve information storage. The information may be computer-readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic tape, a magnetic disk storage or other magnetic memories or any other non-transmission medium, which may be used to store information that can be accessed by a computing device. As defined herein, the computer-readable media do not include transitory media, such as modulated data signals and carriers.

The input/output interface 613 is used to connect to an input/output module to implement information input and output. The input output/module may be configured as a component in the device (not shown in the figure), or it can be externally connected to the device to provide corresponding functions. The input devices may include a keyboard, a mouse, a touch screen, a microphone, various sensors, etc., and the output devices may include a display, a speaker, a vibrator, an indicator light, etc.

The network interface 614 is used to connect to a communication module (not shown in the figure) to implement communication and interaction between the device and other devices. The communication module may achieve communication through wired means (such as USB, network cable, etc.) or wireless means (such as mobile network, WIFI, Bluetooth, etc.).

The bus 630 comprises a pathway for transmitting information among the various components of the device (e.g., the processor 610, the video display adapter 611, the disk drive 612, the input/output interface 613, the network interface 614, and the memory 620).

It should be noted that although the above device only shows the processor 610, the video display adapter 611, the disk drive 612, the input/output interface 613, the network interface 614, the memory 620, the bus 630, the device may further include other required components to achieve normal operation during an example implementation process. Further, it would be appreciated by those skilled in the art that the above-mentioned device may only include components needed for implementing the solutions of the present disclosure and does not necessarily include all components shown in the figures.

As can be seen from the description of the above embodiments, it is clear to those skilled in the art that the present disclosure can be implemented by means of software plus the necessary general hardware platform. Based on such an understanding, the part of the technical solution of the present disclosure, which is essential or contributes to the conventional techniques, can be embodied in the form of a software product. The computer software product can be stored in a storage medium, such as a ROM/RAM, a magnetic disk, and an optical disk, and include several instructions for enabling a computer device (which may be a personal computer, a server, a network device, or the like) to execute the methods described in the embodiments or some parts of the embodiments of the present disclosure.

The various embodiments in this specification are all described in a progressive manner. The various embodiments may refer to other embodiments for the same or similar parts, and each of the embodiments focuses on the parts differing from the other embodiments. In particular, the system or system embodiments are basically similar to the method embodiments, the description for these embodiments is thus relatively brief, and the description of the method embodiments may be referred to for relevant details. The system and system embodiments described above are only examples, wherein the units described as separate components may or may not be physically separated; and the components displayed as units may or may not be physical units. That is, the units may be located in one place, or may be distributed on a plurality of network units. Some or all of the modules may be selected according to actual needs to achieve the objectives of the solutions of the embodiments. Those of ordinary skill in the art may understand and implement the embodiments without creative efforts.

The method and the electronic device for re-engaging users and providing suggestion information provided by the present disclosure have been introduced in detail above. The principles and implementations of the present disclosure are described with specific examples herein. The descriptions of the above embodiments are only used to help understand the methods and the core idea of the present disclosure. At the same time, for those skilled in the art, according to the idea of the present disclosure, there will be modifications in specific implementations and the application scope. In conclusion, the content of the present specification should not be construed as a limitation to the present disclosure.

The present disclosure may further be understood with clauses as follows.

Clause 1. A user re-engagement method, the method comprising:
acquiring user behavior data generated in a first service module of a commodity information service system, the user behavior data including behavior data generated in a process of a user interacting with the first service module by browsing commodity information published by the first service module;
determining, by analyzing the user behavior data, a target user having a commodity purchase intention and having difficulty in finding or deciding on commodities in the first service module; and
after determining the target user, re-engaging the target user with a second service module of the commodity information service system so that the target user initiates a purchase form in the second service module and interact therewith.

Clause 2. The method according to clause 1, wherein:
the behavior data includes behavior data generated by the user in a plurality of sub-service modules within the first service module; and
the acquiring the user behavior data generated in the first service module of the commodity information service system includes acquiring, from a general user behavior data stream log, a user behavior data stream generated in the first service module so as to determine the target user by extracting and analyzing valid data therefrom,
wherein the general user behavior data stream log is used to collect the user behavior data from the first service module and provide data services for downstream applications.

Clause 3. The method according to clause 1, wherein:
the method further comprises acquiring pre-configured re-engagement condition information, the re-engagement condition information being generated by selecting from a plurality of data metrics and configuring thresholds, the selected data metrics and configured thresholds being determined based on user behaviors related to commodity purchase intentions and difficulty in finding or deciding on commodities in the first service module; and
the determining, by analyzing the user behavior data, the target user having the commodity purchase intention and having difficulty in finding or deciding on the commodities in the first service module includes:
   aggregating data values under various data metrics on a user-by-user basis by analyzing the user behavior data; and
   determining the target user according to the data values under the plurality of data metrics that match a re-engagement condition.

Clause 4. The method according to clause 3, wherein the re-engagement condition information is adjustable, so that when a user re-engagement effect is not as expected, the re-engagement condition is adjusted by selecting other data metrics and/or configuring other thresholds.

Clause 5. The method according to clause 1, further comprising performing flow control and/or user fatigue control in a process of re-engaging the target user with the second service module of the commodity information service system.

Clause 6. The method according to clause 1, further comprising:
in the process of re-engaging the target user with the second service module of the commodity information service system, assembling a marketing content and sending the marketing content to the target user through a target marketing channel,
wherein the marketing content is related to the commodity information associated with real-time behavior data.

Clause 7. The method according to clause 6, wherein:
the marketing content includes a landing page corresponding to a marketing notification message;
the landing page is generated through a visual construction system; and
the user behavior data is collected by adding anchors in the landing page so as to track a user re-engagement effect.

Clause 8. A user re-engagement method, the method comprising:
providing, in response to a request to configure a user re-engagement condition, a plurality of alternative data metrics, the plurality of alternative data metrics being related to behavior data generated in a process of a user interacting with a first service module of a commodity information service system by browsing commodity information published by the first service module;
generating a user re-engagement condition according to at least one selected data metric and configured threshold information; and
configuring the user re-engagement conditions into a user re-engagement service, so that the user re-engagement service determines, after acquiring user behavior data generated in the first service module and aggregating the user behavior data into data values under the data metrices, a target user having commodity purchase intention and having difficulty in finding or deciding on commodities in the first service module according to matches of the user re-engagement condition, and re-engages the target user by bringing the target user to a second service module of the commodity information service system, so as to enable the target user to initiate a purchase form in the second service module to interact.

Clause 9. The method according to clause 8, wherein the user re-engagement condition information is adjustable, so that when a user re-engagement effect is not as expected, the re-engagement condition is adjusted by selecting other data metrics and/or configuring other thresholds.

Clause 10. A method for providing suggestion information comprising:
acquiring user behavior data generated in a first service module of a commodity information service system, the user behavior data including behavior data generated in a process of a user interacting with the first service module by browsing commodity information published by the first service module;
determining, by analyzing the user behavior data, a target user having a commodity purchase intention and having difficulty in finding or deciding on commodities in the first service module; and
providing, after determining the target user, suggestion information to the target user so that the target user initiates a purchase form in a second service module of the commodity information service system to interact.

Clause 11. A computer-readable storage medium having a computer program stored thereon that, when executed by a processor, causes the processor to execute steps of the method according to any one of clauses 1 to 10.

Clause 12. An electronic device comprising:
one or more processors; and
a memory associated with the one or more processors, the memory being configured to store program instructions that, when read and executed by the one or more processors, cause the one or more processors to execute steps of the method according to any one of clauses 1 to 10.

What is claimed is:

1. A user re-engagement method, the user re-engagement method comprising:
acquiring user behavior data generated in a first service module of a commodity information service system, the user behavior data including behavior data generated in a process of a user interacting with the first service module by browsing commodity information published by the first service module;
determining, by analyzing the user behavior data, a target user having a commodity purchase intention and having difficulty in finding or deciding on commodities in the first service module; and
after determining the target user, re-engaging the target user with a second service module of the commodity information service system so that the target user initiates a purchase form in the second service module and interact therewith.

2. The user re-engagement method according to claim 1, wherein:
the behavior data includes behavior data generated by the user in a plurality of sub-service modules within the first service module.

3. The user re-engagement method according to claim 1, wherein the acquiring the user behavior data generated in the first service module of the commodity information service system includes acquiring, from a general user behavior data stream log, a user behavior data stream generated in the first service module so as to determine the target user by extracting and analyzing valid data therefrom,
wherein the general user behavior data stream log is used to collect the user behavior data from the first service module and provide data services for downstream applications.

4. The user re-engagement method according to claim 1, further comprising:
acquiring pre-configured re-engagement condition information, the pre-configured re-engagement condition information being generated by selecting from a plurality of data metrics and configuring thresholds; and
determining selected data metrics and configured thresholds based on user behaviors related to commodity purchase intentions and difficulty in finding or deciding on commodities in the first service module.

5. The user re-engagement method according to claim 4, wherein the determining, by analyzing the user behavior data, the target user having the commodity purchase intention and having difficulty in finding or deciding on the commodities in the first service module includes:
aggregating data values under various data metrics on a user-by-user basis by analyzing the user behavior data; and
determining the target user according to the data values under the plurality of data metrics that match a re-engagement condition.

6. The user re-engagement method according to claim 5, wherein the pre-configured re-engagement condition information is adjustable, so that when a user re-engagement effect is not as expected, the re-engagement condition is adjusted by selecting other data metrics and/or configuring other thresholds.

7. The user re-engagement method according to claim 1, further comprising performing flow control and/or user fatigue control in a process of re-engaging the target user with the second service module of the commodity information service system.

8. The user re-engagement method according to claim 1, further comprising:
in the process of re-engaging the target user with the second service module of the commodity information service system, assembling a marketing content and sending the marketing content to the target user through a target marketing channel,
wherein the marketing content is related to the commodity information associated with real-time behavior data.

9. The user re-engagement method according to claim 8, wherein:
the marketing content includes a landing page corresponding to a marketing notification message;
the landing page is generated through a visual construction system; and
the user behavior data is collected by adding anchors in the landing page so as to track a user re-engagement effect.

10. One or more memories storing thereon computer-readable instructions that, when executed by one or more processors, cause the one or more processors to perform acts comprising:
providing, in response to a request to configure a user re-engagement condition, a plurality of alternative data metrics related to behavior data generated in a process of a user interacting with a first service module of a commodity information service system by browsing commodity information published by the first service module;
generating a user re-engagement condition according to at least one selected data metric and configured threshold information; and
configuring the user re-engagement condition into a user re-engagement service.

11. The one or more memories according to claim 10, wherein the acts further comprise:
determining, by the user re-engagement service, after acquiring user behavior data generated in the first service module and aggregating the user behavior data into data values under the plurality of plurality of data metrics, a target user having commodity purchase intention and having difficulty in finding or deciding on commodities in the first service module according to matches of the user re-engagement condition; and
re-engages the target user by bringing the target user to a second service module of the commodity information service system, so as to enable the target user to initiate a purchase form in the second service module to interact.

12. The one or more memories according to claim 11, wherein the user re-engagement condition is adjustable, so that when a user re-engagement effect is not as expected, the re-engagement condition is adjusted by selecting other data metrics and/or configuring other thresholds.

13. A device comprising:
one or more processors; and
one or more memories storing thereon computer-readable instructions that, when executed by the one or more processors, cause the one or more processors to perform acts comprising:
acquiring user behavior data generated in a first service module of a commodity information service system, the user behavior data including behavior data generated in a process of a user interacting with the first service module by browsing commodity information published by the first service module;
determining, by analyzing the user behavior data, a target user having a commodity purchase intention and having difficulty in finding or deciding on commodities in the first service module; and
providing, after determining the target user, suggestion information to the target user so that the target user initiates a purchase form in a second service module of the commodity information service system to interact.

14. The device according to claim 13, wherein the acquiring the user behavior data generated in the first service module of the commodity information service system includes acquiring, from a general user behavior data stream log, a user behavior data stream generated in the first service module so as to determine the target user by extracting and analyzing valid data therefrom,
wherein the general user behavior data stream log is used to collect the user behavior data from the first service module and provide data services for downstream applications.

15. The device according to claim 13, further comprising:
selecting data metrics from a plurality of data metrics and configured thresholds based on user behaviors related to commodity purchase intentions and difficulty in finding or deciding on commodities in the first service module;
generating re-engagement condition information based on the selected data metrics and configuring thresholds; and
acquiring the re-engagement condition information.

16. The device according to claim 15, wherein the determining, by analyzing the user behavior data, the target user having the commodity purchase intention and having difficulty in finding or deciding on the commodities in the first service module includes:
aggregating data values under various data metrics on a user-by-user basis by analyzing the user behavior data; and
determining the target user according to the data values under the plurality of data metrics that match a re-engagement condition.

17. The device according to claim 16, wherein the re-engagement condition information is adjustable, so that when a user re-engagement effect is not as expected, the re-engagement condition is adjusted by selecting other data metrics and/or configuring other thresholds.

18. The device according to claim 13, wherein the acts further comprise:
in the process of re-engaging the target user with the second service module of the commodity information service system, assembling a marketing content and sending the marketing content to the target user through a target marketing channel.

19. The device according to claim 18, wherein the marketing content is related to the commodity information associated with real-time behavior data.

20. The device according to claim 18, wherein:
the marketing content includes a landing page corresponding to a marketing notification message;
the landing page is generated through a visual construction system; and
the user behavior data is collected by adding anchors in the landing page so as to track a user re-engagement effect.
